(19) United States
(12) Patent Application Publication
(10) Pub. No.: US 2025/0355244 A1
(43) Pub. Date: Nov. 20, 2025

(54) ZOOM LENS AND IMAGE PICKUP APPARATUS

(71) Applicant: CANON KABUSHIKI KAISHA, Tokyo (JP)

(72) Inventor: Takashi OKADA, Saitama (JP)

(21) Appl. No.: 19/190,295

(22) Filed: Apr. 25, 2025

(30) Foreign Application Priority Data
May 17, 2024 (JP) 2024-080635
Feb. 14, 2025 (JP) 2025-022075

(51) Int. Cl. G02B 27/00; G02B 13/00; G02B 15/14; G02B 27/42

(52) U.S. Cl. CPC G02B 27/0062; G02B 13/009; G02B 15/1421; G02B 15/1425; G02B 15/143503; G02B 15/144113; G02B 27/4211

(57) ABSTRACT

A zoom lens includes a plurality of lens units. Each distance between adjacent lens units changes during zooming. At least one of the plurality of lens units has a diffractive surface with controlled wavelength dispersion. A predetermined inequality is satisfied.

### BACKGROUND

### Technical Field

The present disclosure relates to a zoom lens suitable for imaging.

### Description of Related Art

As a zoom lens, Japanese Patent Application Laid-Open No. 09-197273 discloses a zoom lens in which chromatic aberration is corrected using a diffractive optical element (DOE). US Patent Application Publication No. 2021/333575 discloses a metasurface zoom lens that obtains a magnification variation effect by utilizing a phase change of a material. US Patent Application Publication No. 2021/231909 discloses a zoom lens that obtains a magnification variation effect by moving a metasurface lens in a direction orthogonal to the optical axis.

### SUMMARY

A zoom lens according to one aspect of the present disclosure includes a plurality of lens units. Each distance between adjacent lens units changes during zooming. At least one of the plurality of lens units has a diffractive surface with controlled wavelength dispersion. The following inequality is satisfied:

$$- 0.28 \leq 1 / {v}_{0} \leq 0.$$

where ν₀ is an Abbe number of the diffractive surface and satisfies the following equation, a reference wavelength is d-line, a primary dispersion is F-line and C-line, ψ(λ_{d}), ψ(λ_{F}) and ψ(λ_{C}) are optical path difference functions at wavelengths of the d-line, the F-line and the C-line, respectively, P(λ_{d}), P(λ_{F}) and P(λ_{C}) are optical path difference dispersions of a surface at the wavelengths of the d-line, the F-line, and the C-line, respectively:

$$\frac{1}{{v}_{0}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )} .$$

An image pickup apparatus having the above zoom lens also constitutes another aspect of the present disclosure.

A zoom lens according to another aspect of the present disclosure includes a plurality of lens units. Each distance between adjacent lens units changes during zooming. At least one of the plurality of lens units has a diffractive surface with controlled wavelength dispersion. At least one of the plurality of lens units has a refractive surface. The following inequality is satisfied:

$$1 / {v}_{0} \leq 0.00$$

where ν₀ is an Abbe number of the diffractive surface and satisfies the following equation, a reference wavelength is d-line, a primary dispersion is F-line and C-line, ψ(λ_{d}), ψ(λ_{F}) and ψ(λ_{C}) are optical path difference functions at wavelengths of the d-line, the F-line and the C-line, respectively, P(λ_{d}), P(λ_{F}) and P(λ_{C}) are optical path difference dispersions of a surface at the wavelengths of the d-line, the F-line, and the C-line, respectively:

$$\frac{1}{{v}_{0}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )} .$$

An image pickup apparatus having the above zoom lens also constitutes another aspect of the present disclosure.

Further features of various embodiments of the disclosure will become apparent from the following description of embodiments with reference to the attached drawings.

### BRIEF DESCRIPTION OF THE DRAWINGS

FIG. 1 is a sectional view of a zoom lens according to Example 1.

FIGS. 2A, 2B, and 2C are aberration diagrams of the zoom lens according to Example 1 at a wide-angle end, an intermediate zoom position, and a telephoto end, respectively.

FIG. 3 is a sectional view of a zoom lens according to Example 2.

FIGS. 4A, 4B, and 4C are aberration diagrams of the zoom lens according to Example 2 at a wide-angle end, an intermediate zoom position, and a telephoto end, respectively.

FIG. 5 is a sectional view of a zoom lens according to Example 3.

FIGS. 6A, 6B, and 6C are aberration diagrams of the zoom lens according to Example 3 at a wide-angle end, an intermediate zoom position, and a telephoto end, respectively.

FIG. 7 is a sectional view of a zoom lens according to Example 4.

FIGS. 8A, 8B, and 8C are aberration diagrams of the zoom lens according to Example 4 at a wide-angle end, an intermediate zoom position, and a telephoto end, respectively.

FIG. 9 is a sectional view of a zoom lens according to Example 5.

FIGS. 10A, 10B, and 10C are aberration diagrams of the zoom lens according to Example 5 at a wide-angle end, an intermediate zoom position, and a telephoto end, respectively.

FIG. 11 illustrates an image pickup apparatus having any one of the zoom lenses according to Examples 1 to 5.

### DETAILED DESCRIPTION

Referring now to the accompanying drawings, a description will be given of examples according to the disclosure.

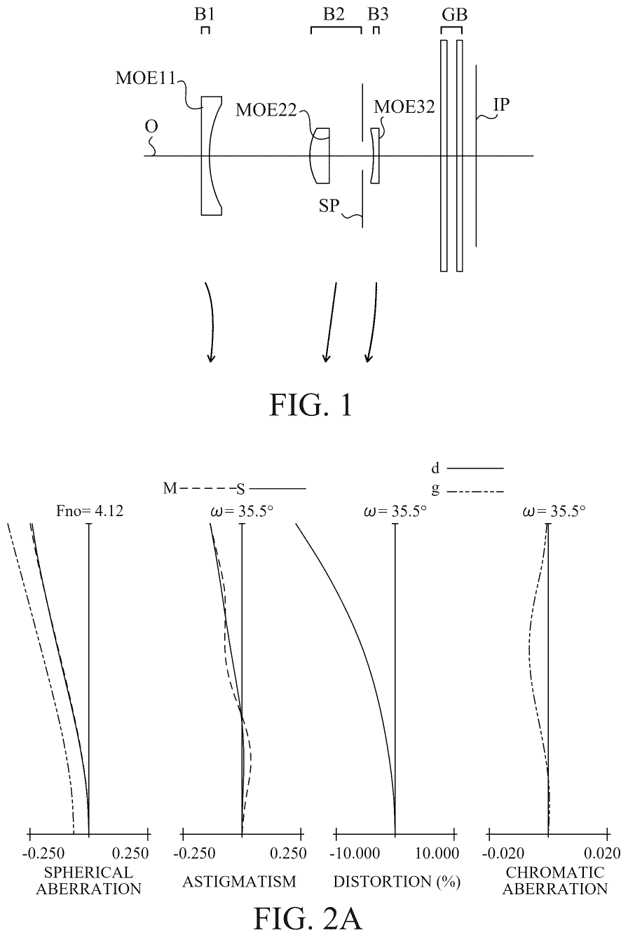

FIGS. 1, 3, 5, 7, and 9 illustrate the configurations of zoom lenses according to Examples 1 to 5 at a wide-angle end. O represents an optical axis. Bi (i is an order counted from an object side) is an i-th lens unit, and MOE is a diffractive surface with controlled wavelength dispersion (dispersion-controlled hereinafter). A first digit labeled to MOE identifies a lens unit (i-th lens unit) that includes the diffractive surface, and a second digit on the right side of the first digit indicates that the diffractive surface is an object-side surface of a DOE (lens) if the second digit is 1, and indicates that the diffractive surface is an image-side surface of a DOE if the second digit is 2.

SP represents an aperture stop, and IP represents an image plane. An imaging surface of an image sensor such as a CCD sensor or CMOS sensor, or a film surface (photosensitive surface) of a silver film is located on the image plane IP.

First, before Examples 1 to 5 are specifically discussed, a description will be given of the matters common to each example.

The zoom lens according to each example includes a plurality of lens units. In each example, the lens unit has refractive power that refracts light when parallel light enters it, and provides a focusing or diverging effect. The lens unit is a group of optical elements such as one or more lenses that may or may not move together during zooming, focusing, and image stabilization. Each distance between adjacent lens units changes during zooming and focusing. A wide-angle end and a telephoto end, which are two ends of zooming, respectively indicate zoom states of a maximum angle of view (shortest focal length) and a minimum angle of view (longest focal length) when the lens unit that moves during zooming is located at two ends of a mechanically movable or controllable range on the optical axis. The lens unit may also include an aperture stop (diaphragm).

The image pickup apparatus in which the zoom lens according to any one of the examples is intended to be used moves each lens unit so as to minimize a distance between the lens units and reduce the size of the entire image pickup apparatus when the zoom lens is retracted. Since the thickness in the optical axis direction of the zoom lens retracted in an image pickup apparatus (referred to as the retracted state of the zoom lens hereinafter) is determined by the accumulated thickness of each lens unit, the thickness of each lens unit is reduced in order to reduce the size of the image pickup apparatus.

On the other hand, in order to obtain good optical performance of a zoom lens, the aberration (chromatic aberration and geometric aberration) occurring in each lens unit is suppressed. However, in a case where a plurality of lenses is used to suppress the aberration of each lens unit, the thickness of the lens unit increases. As a result, the thickness in the retracted state of the zoom lens (that is, the thickness of the image pickup apparatus in which the zoom lens is retracted) increases.

In the zoom lens according to each example, at least one lens unit includes a dispersion-controlled diffractive surface in order to reduce the thickness of that lens unit while the aberration in that lens unit is reduced.

The DOE having a dispersion-controlled diffractive surface for each example is different from the conventional blazed DOE. The dispersion of the blazed DOE disclosed in Japanese Patent Application Laid-Open No. 09-197273 is −3.45, which is an extremely high dispersion when expressed in terms of the Abbe number based on the d-line. Thus, if the refractive power of the diffractive surface is increased, a large chromatic aberration amount occurs. As described in Japanese Patent Application Laid-Open No. 09-197273, the refractive power of the blazed DOE is limited to about 10% of the refractive power of the lens unit.

The zoom lenses disclosed in US Patent Applications Publication Nos. 2021/333575 and 2021/231909, achieve a zoom effect by using a metasurface, but requires temperature control and displacement control of the lens unit in a direction orthogonal to the optical axis, unlike a general zoom lens.

The zoom lenses according to the present examples can solve these problems by using a dispersion-controlled diffractive surface.

In each example, the DOE having a diffractive surface may have negative dispersion. In a case where the diffractive surface in the DOE having negative dispersion is provided with the same refractive power as that of the lens unit, chromatic aberration caused by another lens surface can be cancelled. As a result, part of the refracting action of the other lens surface can be shared, achromatization can be obtained, and the aberration in the lens unit can be suppressed.

In each example, the following inequality (1) may be satisfied:

$$0.15 \leq fi / fmi \leq 10.00 \qquad ( 1 )$$

where fi is a focal length of the lens unit including the dispersion-controlled diffractive surface, and fmi is a focal length of the dispersion-controlled diffractive surface.

In a case where the refractive power of the diffractive surface becomes too strong so that fi/fmi becomes higher than the upper limit of inequality (1), the structure of the diffractive surface becomes complicated and it becomes difficult to manufacture the diffractive surface. In a case where the refractive power of the diffractive surface becomes too weak so that fi/fmi becomes lower than the lower limit of inequality (1), the share of the refractive power of the lens unit including that diffractive surface is reduced, the refractive power of another lens surface in that lens unit increases, and it becomes difficult to correct geometric aberration.

The zoom lens according to each example may satisfy the following inequality (2):

$$- 0.28 \leq 1 / {v}_{0} \leq 0.00 \qquad ( 2 )$$

where ν₀ is an Abbe number of the dispersion-controlled diffractive surface.

The Abbe number ν₀ of the dispersion-controlled diffractive surface is defined by the following equation:

$$\frac{1}{{v}_{0}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )} .$$

Here, the reference wavelength is the d-line (λd=0.58756 [μm]), the primary dispersion is the F-line (λ_{F}=0.48613 [μm]) and the C-line (λ_{C}=0.65627 [μm]), and ψ(λ_{d}), ψ(λ_{F}), and ψ(λ_{C}) are optical path difference functions at the wavelengths of the d-line, F-line, and C-line, respectively. P(λ_{d}), P(λ_{F}), and P(λ_{C}) are optical path difference dispersions of a surface at the wavelengths of the d-line, F-line, and C-line, respectively.

An optical element provided with refractive power can bend light of a specific wavelength in a specific direction, but generates chromatic aberration unless the behavior of light of a wavelength different from the specific wavelength is controlled. Therefore, setting the Abbe number ν₀ of the diffractive surface so as to satisfy inequality (2) can satisfactorily correct chromatic aberration even if the diffractive surface is provided with a large share of the refractive power of the lens unit including the dispersion-controlled diffractive surface to satisfy inequality (1).

In a case where the dispersion of the diffractive surface becomes positive so that 1/ν₀ becomes higher than the upper limit of inequality (2), chromatic aberration can be satisfactorily corrected, but the refractive power becomes too weak. As a result, the diffractive surface will no longer be able to share the refractive power of the lens unit, and it becomes difficult to correct both geometric aberration and chromatic aberration. In a case where the dispersion of the diffractive surface becomes too negative so that 1/λ₀ becomes lower than the lower limit of inequality (2), the diffractive surface cannot be provided with refractive power, and a correction effect of geometric aberration becomes insufficient.

However, in a case where an effect of correcting geometric aberration may be insufficient (for example, in a case where geometric aberration is corrected by image processing in the image pickup apparatus), 1/ν₀ may be lower than the lower limit of inequality (2). In other words, 1/ν₀≤0.00 may be satisfied.

The zoom lens according to each example that has the above configuration and satisfies inequalities (1) and (2) can reduce the thickness and size of the image pickup apparatus equipped with the zoom lens while satisfactorily correcting chromatic aberration and geometric aberration.

Inequality (1) may be replaced with inequality (1a) below:

$$0.15 \leq fi / fmi \leq 7.00 \qquad ( 1 a )$$

Inequality (1) may be replaced with inequality (1b) below:

$$0.15 \leq fi / fmi \leq 3.00 \qquad ( 1 b )$$

Inequality (2) may be replaced with inequality (2a) below:

$$- 0.15 < 1 / {v}_{0} \leq 0.00 \qquad ( 2 a )$$

Inequality (2) may be replaced with inequality (2b) below:

$$- 0.10 < 1 / {v}_{0} \leq 0.00 \qquad ( 2 b )$$

The zoom lens according to each example may have the following configuration and may satisfy at least one of the following inequalities (3) to (7).

First, all surfaces of a zoom lens may have refractive surfaces, rather than diffractive surfaces, because if both surfaces of the DOE are diffractive surfaces, it becomes difficult to manufacture the DOE. Another reason is that if the DOE is a thin lens, there will be no significant difference in the positions where light passes between the object-side surface and the image-side surface, and a degree of freedom in aberration correction becomes insufficient. Thus, the DOE may have a sufficient thickness, and may have a diffractive surface as one surface and a refractive surface as the other surface, as in Example 5 described later. A single refractive surface can reduce the difficulty of manufacturing the DOE. In order to reduce the difficulty of manufacturing the diffractive surface, the base surface that forms the diffractive surface may be a flat surface.

A lens unit including a dispersion-controlled diffractive surface may include two lenses or less. This is because if a lens unit has three or more lenses and the thickness of the lens unit increases, the thickness in the retracted state of the zoom lens will increase. In a case where all the lens units of the zoom lens can include two lenses or less, the thickness in the retracted state of the zoom lens can be suppressed.

In a case where a concave surface closest to the image plane of a lens unit is close to a concave surface closest to an object of the adjacent lens unit, a distance between the lens units cannot be sufficiently reduced to prevent the peripheral portions of these concave surfaces from interfering with each other. As a result, the thickness in the retracted state of the zoom lens cannot be reduced. Thus, such a configuration may be avoided.

The zoom lens according to each example may satisfy the following inequality (3):

$$0.05 \leq Dsum / √ ( fw \cdot ft ) \leq 0.8 \qquad ( 3 )$$

where Dsum is a sum of the thicknesses on the optical axis of all the lens units in the zoom lens, fw and ft are focal lengths at a wide-angle end and a telephoto end in an in-focus state on an object at infinity (referred to as “in an in-focus state at infinity” hereinafter), respectively.

Inequality (3) defines a proper range of the overall thickness Dsum of the lens units normalized by the focal lengths fw and ft of the zoom lens in order to suppress the thickness in the retracted state of the zoom lens. In a case where the overall thickness of the lens unit becomes too large so that Dsum/√(fw·ft) becomes higher than the upper limit of inequality (3), the thickness in the retracted state of the zoom lens increases. In a case where the overall thickness of the lens unit becomes too small so that Dsum/√(fw·ft) becomes lower than the lower limit of inequality (3), the focal length of the zoom lens and the overall length of the zoom lens increase, and it becomes difficult to retract the zoom lens into the image pickup apparatus.

Inequality (3) may be replaced with inequality (3a) below:

$$0.08 \leq Dsum / √ ( fw \cdot ft ) \leq 0.7 \qquad ( 3 a )$$

Inequality (3) may be replaced with inequality (3b) below:

$$0.1 \leq Dsum / √ ( fw \cdot ft ) \leq 0.6 \qquad ( 3 b )$$

The zoom lens according to each example may satisfy the following inequality (4):

$$0.1 \leq Dsum / ( ft \cdot tan ω T ) \leq 2. \qquad ( 4 )$$

where ωT is a half angle of view of the zoom lens in the in-focus state at infinity at the telephoto end.

Inequality (4) defines a proper range of the overall thickness Dsum of the lens unit normalized by the focal length ft and the half angle of view ωT at the telephoto end of the zoom lens in order to reduce the thickness in the retracted state of the zoom lens. In a case where the overall thickness of the lens unit increases and Dsum/(ft tan ωT) becomes higher than the upper limit of inequality (4), the thickness in the retracted state of the zoom lens increases. In a case where the overall thickness of the lens unit is reduced and Dsum/(ft tan ωT) becomes lower than the lower limit of inequality (4), the diameter of the image circle increases for the zoom lens and it can cause problems with oblique incidence on the image sensor in the image pickup apparatus, or it becomes difficult to retract the zoom lens into the image pickup apparatus due to its large size.

Inequality (4) may be replaced with inequality (4a) below:

$$0.15 \leq Dsum / ( ft \cdot tan ω T ) \leq 1.80 \qquad ( 4 a )$$

Inequality (4) may be replaced with inequality (4b) below:

$$0.18 \leq Dsum / ( ft \cdot tan ω T ) \leq 1.50 \qquad ( 4 b )$$

At least one pair of adjacent lens units in the zoom lens according to each example satisfies the following inequality (5):

$$\vert ( R ( i + 1 ) 1 Ri 2 ) / ( R ( i + 1 ) 1 + Ri 2 ) \vert \leq 2. 0 ( 5 ) \qquad ( 5 )$$

where i is an order of the lens unit counted from the object side, Ri2 is a radius of curvature of a lens surface closest to the image plane of the i-th lens unit, and R(i+1)1 is a radius of curvature of a lens surface closest to the object of the (i+1)-th lens unit. In a case where the lens surface is aspheric, a radius of curvature is a radius of curvature of a reference spherical surface of that lens surface.

Inequality (5) defines a proper range of a shape factor of an air lens between the i-th lens unit and the (i+1)-th lens unit. In a case where the air lens has a biconvex shape (i.e., both lens surfaces of the air lens are concave), it is difficult to narrow a distance between the i-th lens unit and the (i+1)-th lens unit to avoid interference between the lenses on both sides of the air lens, even if the thickness of the i-th lens unit and the (i+1)-th lens unit is reduced. On the other hand, in a case where the air lens has a meniscus shape, the concave surface of one of the lenses on both sides can be inserted into the convex surface of the other, so that the distance between the i-th lens unit and the (i+1)-th lens unit in the retracted state of the zoom lens can be reduced.

In a case where the shape factor of the air lens becomes higher than the upper limit of inequality (5), the air lens becomes biconvex, and as discussed above, even if the thickness of the i-th lens unit and the (i+1)-th lens unit is reduced, the distance between these lens units cannot be reduced. In terms of aberration correction, in a case where the air lens has a biconvex shape (or biconcave shape), the refractive powers on both sides of the air lens increase, so the aberrations generated on both sides increase, and the sensitivity in manufacturing increases.

Inequality (5) may be replaced with inequality (5a) below:

$$\vert ( R ( i + 1 ) 1 Ri 2 ) / ( R ( i + 1 ) 1 + Ri 2 ) \vert \leq 1. 5 \qquad ( 5 a )$$

Inequality (5) may be replaced with inequality (5b) below:

$$\vert ( R ( i + 1 ) 1 Ri 2 ) / ( R ( i + 1 ) 1 + Ri 2 ) \vert \leq 1. 2 \qquad ( 5 b )$$

The zoom lenses according to Examples 1, 4, and 5 are negative-lead type zoom lenses with a refractive power arrangement that includes, in order from the object side to the image side, a first lens unit with negative refractive power and a second lens unit with positive refractive power. This configuration is difficult to increase the zoom magnification, but is advantageous for reducing the overall length (reducing the size) and widening the angle. In such negative-lead zoom lenses, the following inequality (6) may be satisfied:

$$- 2.1 \leq f 1 / f 2 \leq - 1.0 \qquad ( 6 )$$

where f1 and f2 are focal lengths of the first lens unit and the second lens unit, respectively.

Inequality (6) defines a proper refractive power arrangement for reducing the size of the zoom lens. In a case where f1/f2 becomes higher than the upper limit of inequality (6), the refractive powers of the first and second lens units increase, and the refractive power arrangement increases a moving amount of the second lens unit. In a case where the refractive powers of the first and second lens units are thus strong, it becomes difficult to correct the geometric aberration, and the refractive power of the diffractive surface becomes strong. In addition, in a case where a moving amount of the second lens unit increases, the F-number at the telephoto end tends to increases (becomes darker). In a case where f1/f2 becomes lower than the lower limit of inequality (6), the overall length at the wide-angle end increases, and a refractive power arrangement tends to increase the diameter of the first lens unit. As a result, the thickness of the first lens unit increases and it becomes difficult to reduce the length in the retracted state of the zoom lens.

Inequality (6) may be replaced with inequality (6a) below:

$$- 2 \text{.0} \leq f 1 / f 2 \leq - 1.1 \qquad ( 6 a )$$

Inequality (6) may be replaced with inequality (6b) below:

$$- 1.95 \leq f 1 / f 2 \leq - 1.20 \qquad ( 6 b )$$

The zoom lenses according to Examples 2 and 3 have positive-lead type refractive power arrangement that includes, in order from the object side to the image side, a first lens unit with positive refractive power, and a second lens unit with negative refractive power. This configuration is advantageous for achieving a high zoom ratio of over 8×, and can easily reduce the overall length at the wide-angle end. In such a positive-lead zoom lens, the following inequality (7) may be satisfied:

$$- 0.80 \leq f 2 / ft \leq - 0.05 \qquad ( 7 )$$

Inequality (7) defines a proper range of focal length f2 of the second lens unit relative to the focal length ft at the telephoto end of the zoom lens. In a case where the refractive power of the second lens unit increases and f2/ft becomes higher than the upper limit of inequality (7), a zoom effect caused by its movement increases, but the Petzval sum increases on the negative side, and it becomes difficult to correct the curvature of field over the entire zoom range. In a case where the refractive power of the second lens unit is reduced and f2/ft becomes lower than the lower limit of inequality (7), the required zoom ratio cannot be obtained or the overall length of the zoom lens at the telephoto end increases, and it becomes difficult to reduce the thickness in the retracted state of the zoom lens.

Inequality (7) may be replaced with inequality (7a) below:

$$- 0.70 \leq f 2 / ft \leq - 0.10 \qquad ( 7 a )$$

Inequality (7) may be replaced with inequality (7b) below:

$$- 0.60 \leq f 2 / ft \leq - 0.15 \qquad ( 7 b )$$

Examples 1 to 5 will be described in detail below. After Example 5, the numerical values corresponding to Examples 1 to 5 are illustrated.

### Example 1

A zoom lens according to Example 1 (numerical example 1) illustrated in FIG. 1 has a focal length of 9.06 to 17.72 mm, an F-number of 4.12 to 6.27, and a half angle of view of 35.52° to 24.01°. The zoom lens according to this example includes, in order from the object side to the image side, a first lens unit B1 with negative refractive power, a second lens unit B2 with positive refractive power, an aperture stop SP, and a third lens unit B3 with negative refractive power. All of the lens units B1 to B3 move during zooming, and each distance between adjacent lens units changes. A glass block GB, such as a glass plate that protects the image sensor and a UVIR cut filter, is disposed between the third lens unit B3 and the image plane IP.

During zooming from the wide-angle end to the telephoto end, the first lens unit B1 moves in a convex trajectory toward the image side so that it is positioned closer to the image plane at the telephoto end than at the wide-angle end. The second and third lens units B2 and B3 move toward the object side. Moving the first to third lens units B1 to B3 in this manner can reduce the refractive powers of the first and second lens units B1 and B2, and easily correct aberrations. During zooming from the wide-angle end to the telephoto end, a distance between the first lens unit B1 and the second lens unit B2 decreases, and a distance between the second lens unit B2 and the third lens unit B3 increases. By increasing the distance between the second lens unit B2 and the third lens unit B3 at the intermediate zoom position, the upper line flare of off-axis rays can be cut and aberrations can be satisfactorily corrected.

The first lens unit B1 consists of a single negative lens and has a dispersion-controlled diffractive surface MOE 11 on its object side. The diffractive surface MOE 11 has negative refractive power and corrects chromatic aberration that occurs on the refractive surface on the image side while correcting distortion and curvature of field.

The second lens unit B2 consists of a single positive lens and has a dispersion-controlled diffractive surface MOE 22 on its image side. The diffractive surface MOE 22 has positive refractive power and corrects chromatic aberration that occurs on the refractive surface on the object side while correcting coma and spherical aberration.

The third lens unit B3 consists of a single negative lens and has a dispersion-controlled diffractive surface MOE 32 on its image side. The diffractive surface MOE 32 has negative refractive power and corrects chromatic aberration that occurs on the refractive surface on the object side while correcting coma and curvature of field.

Each of the lenses in the first to third lens units B1 to B3 has a refractive surface with curvature, and is made of a low-dispersion glass lens with an Abbe number of 50 or more based on the d-line to correct chromatic aberration that occurs here. The refractive surface on the image side of the first lens unit B1 is concave, and the refractive surface on the object side of the second lens unit B2 is convex. Thereby, a distance between the first lens unit B1 and the second lens unit B2 can be reduced in the retracted state of the zoom lens.

All of the refractive surfaces with curvature are aspheric, and can satisfactorily correct geometric aberration. Using high-order diffractive surfaces for all the diffractive surfaces can provide an aspheric effect, and correct both geometric aberration and chromatic aberration. All of the diffractive surfaces are formed on a flat surface as a base surface, and can reduce the difficulty in manufacturing each lens.

During focusing from infinity to a close distance, the third lens unit B3 is moved toward the image side. By configuring the third lens unit B3 with one single lens, the weight of the third lens unit B3 can be reduced and the focus drive mechanism can be simple. For image stabilization, the second lens unit B2 is moved (shifted) in a direction orthogonal to the optical axis. Another lens unit may be moved for each of focusing and image stabilization.

Placing the aperture stop SP between the second lens unit B2 and the third lens unit B3 can move the second lens unit B2, which has a large zoom effect, closer to the first lens unit B1 during zooming, and achieve both a high zoom ratio and high performance.

### Example 2

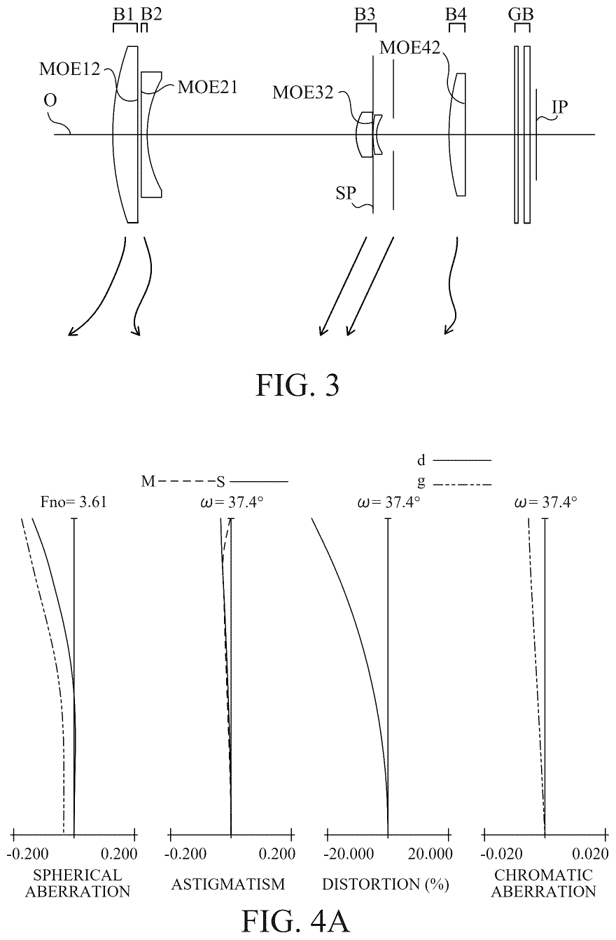

A zoom lens according to Example 2 (numerical example 2) illustrated in FIG. 3 has a focal length of 4.30 to 41.75 mm, an F-number of 3.61 to 6.82, and a half angle of view of 37.44° to 5.30°. The zoom lens according to this example includes, in order from the object side to the image side, a first lens unit B1 with positive refractive power, a second lens unit B2 with negative refractive power, a lens unit B3 with positive refractive power including an aperture stop SP, and a fourth lens unit B4 with positive refractive power. All of the lens units B1 to B4 move during zooming, and each distance between adjacent lens units changes. A glass block GB is disposed between the fourth lens unit B4 and the image plane IP, as in Example 1.

During zooming from the wide-angle end to the telephoto end, the first lens unit B1 moves so that it is located closer to the object at the telephoto end than at the wide-angle end. The second lens unit B2 moves once to the image side so that it is located closer to the object at the telephoto end than at the wide-angle end, then moves to the object side, and then moves to the image side. The third lens unit B3 moves to the object side. The fourth lens unit B4 moves once toward the object side so that it is located closer to the object at the telephoto end than at the wide-angle end, then moves toward the image side, and then moves toward the object side.

Moving the first to fourth lens units B1 to B4 in this manner can reduce the refractive power of each lens unit, easily correct aberrations, and increase a zoom ratio. During zooming from the wide-angle end to the telephoto end, a distance between the first lens unit B1 and the second lens unit B2 increases, a distance between the second lens unit B2 and the third lens unit B3 decreases, and a distance between the third lens unit B3 and the fourth lens unit B4 increases. Moving the fourth lens unit B4 as described above at the intermediate zoom position can suppress the distance between the third lens unit B3 and the fourth lens unit B4, cut the upper line flare of off-axis rays, and satisfactorily correct aberrations.

The first lens unit B1 consists of a single positive lens and has a dispersion-controlled diffractive surface MOE 12 on its image side. The diffractive surface MOE 12 has positive refractive power and effectively corrects chromatic aberration that occurs on the refractive surface on the object side while correcting distortion and curvature of field at the wide-angle end, and spherical aberration at the telephoto end. By providing the diffractive surface MOE 12 on the image side, humans cannot touch the diffractive surface MOE 12 from the outside. Therefore, a protective window, etc. is not necessary.

The second lens unit B2 consists of a single negative lens and has a dispersion-controlled diffractive surface MOE 21 on its object side. The diffractive surface MOE 21 has negative refractive power and effectively corrects chromatic aberration that occurs on the refractive surface on the image side while correcting distortion and curvature of field at the wide-angle end.

The third lens unit B3 consists of a single positive lens and a single negative lens, and has a dispersion-controlled diffractive surface MOE 32 on the image side of the positive lens. The diffractive surface MOE 32 has positive refractive power and corrects coma and spherical aberration over the entire zoom range while correcting chromatic aberration that occurs on the object-side refractive surface.

The fourth lens unit B4 consists of a single positive lens, and has a dispersion-controlled diffractive surface MOE 42 on its image side. The diffractive surface MOE 42 has positive refractive power and corrects chromatic aberration that occurs on the object-side refractive surface while correcting distortion and curvature of field.

All of the lenses in the first to fourth lens units B1 to B4 have refractive surfaces with curvatures, and are made of low-dispersion glass lenses with an Abbe number of 40 or more based on the d-line in order to correct chromatic aberration that occurs here. More specifically, the second lens unit B2, which contributes to miniaturization, and the fourth lens unit B4, which has a low chromatic aberration correction effect, sacrifice the Abbe number and have high refractive indices. A concave image-side refractive surface of the second lens unit B2 and a concave object-side refractive surface of the third lens unit B3 can reduce a distance between the first lens unit B1 and the second lens unit B2 in the retracted state of the zoom lens.

The refractive surface of the third lens unit B3, which has a large spherical aberration correction effect over the overall zoom range, may be aspheric, to effectively correct geometric aberration.

Using high-order diffractive surfaces for all diffractive surfaces can provide an aspheric effect, and correct both geometric aberration and chromatic aberration. All diffractive surfaces are formed on a flat surface as a base surface, and reduce the difficulty of manufacturing each lens.

During focusing from infinity to a close distance, the fourth lens unit B4 is moved toward the object side. By configuring the fourth lens unit B4 as one single lens, the weight of the fourth lens unit B43 can be reduced and the focus drive mechanism can be simple. For image stabilization, the third lens unit B3 is shifted in a direction orthogonal to the optical axis. Another lens unit may be moved for each of focusing and image stabilization.

Placing the aperture stop SP within the third lens unit B3 can move the third lens unit B3, which has a large zoom effect, closer to the second lens unit B2, and achieve both a high zoom ratio and high performance. A flare cut diaphragm is located on the image side of the third lens unit B3 to cut the upper line flare of off-axis rays over the entire zoom range and reduce aberrations.

### Example 3

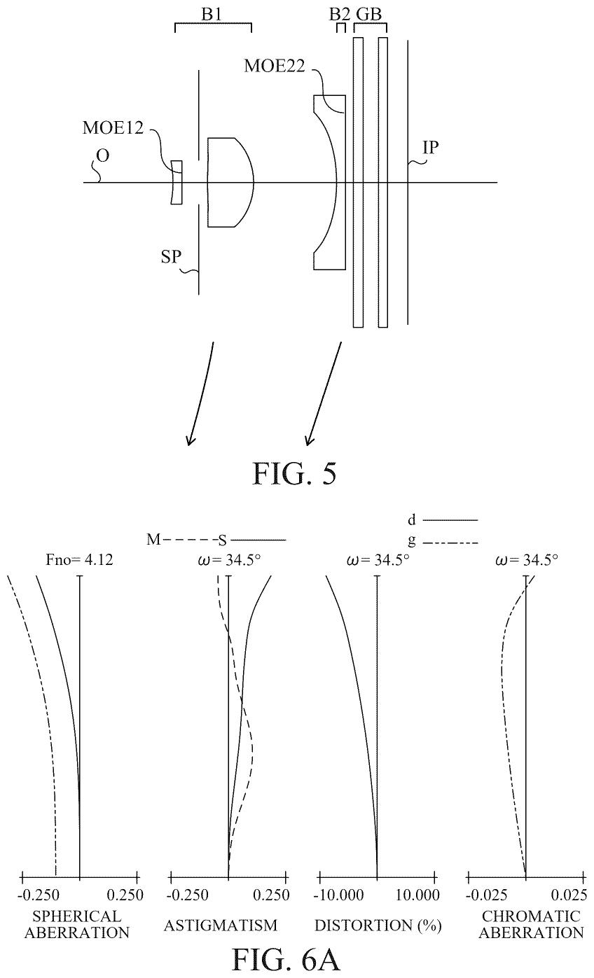

A zoom lens according to Example 3 (numerical example 3) illustrated in FIG. 5 has a focal length of 9.19 to 17.69 mm, an F-number of 4.12 to 7.93, and a half angle of view of 34.50° to 24.04°. The zoom lens according to this example includes, in order from the object side to the image side, a first lens unit B1 with positive refractive power including an aperture stop SP, and a second lens unit B2 with positive refractive power. During zooming, all of the lens units B1 and B2 move, and each distance between adjacent lens units changes. As in Example 1, a glass block GB is disposed between the second lens unit B2 and the image plane IP.

During zooming from the wide-angle end to the telephoto end, the first lens unit B1 and the second lens unit B2 move toward the object side so as to reduce a distance between them. Moving the first and second lens units B1 and B2 in this manner can increase the refractive power of each lens unit, and reduce the overall length of the zoom lens at the wide-angle end.

The first lens unit B1 consists of two lenses, a single negative and a single positive lens, and has a dispersion-controlled diffractive surface MOE 12 on the image side of the negative lens. The diffractive surface MOE 12 has positive refractive power, and corrects spherical aberration, coma, and curvature of field while correcting chromatic aberration generated by other refractive surfaces. By placing the diffractive surface MOE 12 on the image side, humans cannot touch the diffractive surface MOE 12 from the outside. Therefore, a protective window, etc. is not necessary.

The second lens unit B2 consists of a single negative lens and has a dispersion-controlled diffractive surface MOE 22 on its image side. The diffractive surface MOE22 has a negative refractive power and corrects chromatic aberration that occurs on the refractive surface on the object side while correcting curvature of field and distortion.

Each lens in the first and second lens units B1 and B2 has a refractive surface with curvature, and is made of a low-dispersion glass lens with an Abbe number of 40 or more based on the d-line in order to correct chromatic aberration.

A convex image-side surface of the first lens unit B1 and a concave object-side surface of the second lens unit B2 can reduce a distance between the first lens unit B1 and the second lens unit B2 in the retracted state of the zoom lens.

All of the refractive surfaces with curvatures, except for the surface closest to the object of the first lens unit B1, are aspheric, and satisfactorily correct geometric aberration. Using high-order diffractive surfaces for all the diffractive surfaces can provide an aspheric effect, and correct both geometric aberration and chromatic aberration. All diffractive surfaces are formed on a flat surface as a base surface, and reduce the difficulty of manufacturing each lens.

During focusing from infinity to a close distance, the first lens unit B1 is moved toward the object side. In other words, the first lens unit B1, which has a reduced lens diameter and weight, is moved.

Placing the aperture stop SP inside the first lens unit B1 can reduce the diameter of the first lens unit B1 and mitigate oblique incidence.

### Example 4

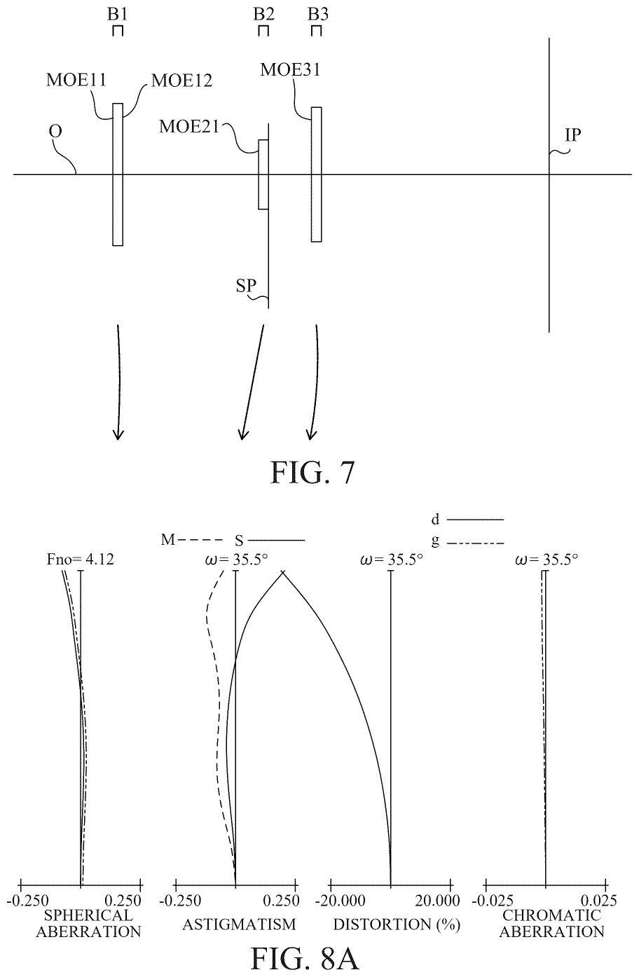

A zoom lens according to Example 4 (numerical example 4) illustrated in FIG. 7 has a focal length of 9.06 to 17.75 mm, an F-number of 4.12 to 5.78, and a half angle of view of 35.52° to 23.97°. The zoom lens according to this example includes, in order from the object side to the image side, a first lens unit B1 with negative refractive power, a second lens unit B2 with positive refractive power, an aperture stop SP, and a third lens unit B3 with negative refractive power. None of the first to third lens units B1 to B3 have curvature, but they have a refractive effect due to their diffractive surfaces, so in this example they are treated as lens units.

During zooming, all of the lens units B1 to B3 move, and each distance between adjacent lens units changes. During zooming from the wide-angle end to the telephoto end, the first lens unit B1 moves in a convex trajectory toward the image side so that it returns to the same position at the telephoto end as that at the wide-angle end. The second and third lens units B2 and B3 move toward the object side. Moving the first to third lens units B1 to B3 in this manner can minimize the overall length of the zoom lens while reducing the refractive powers of the first and second lens units B1 and B2. During zooming from the wide-angle end to the telephoto end, a distance between the first lens unit B1 and the second lens unit B2 decreases, and a distance between the second lens unit B2 and the third lens unit B3 increases. Increasing the distance between the second lens unit B2 and the third lens unit B3 at the intermediate zoom position can cut the upper line flare of off-axis rays and satisfactorily correct aberrations.

The first lens unit B1 consists of a single negative lens, and has dispersion-controlled diffractive surfaces MOE11 and MOE12 on its object side and image side, respectively. The diffractive surface MOE11 on the object side has negative refractive power, and the diffractive surface MOE12 on the image side has positive refractive power. This configuration can correct distortion, curvature of field, and chromatic aberration in a well-balanced manner.

The second lens unit B2 consists of a single positive lens and has a dispersion-controlled diffractive surface MOE 21 on its object side. The diffractive surface MOE 21 has positive refractive power and corrects chromatic aberration that occurs on the object-side surface while correcting coma and spherical aberration.

The third lens unit B3 consists of a single negative lens and has a dispersion-controlled diffractive surface MOE 31 on its image side. The diffractive surface MOE 31 has negative refractive power and corrects chromatic aberration that occurs on the object-side surface while correcting coma and curvature of field.

All of the lenses in the first to third lens units B1 to B3 have flat surfaces on both sides, and are made of low-dispersion glass lenses with an Abbe number of 60 or more based on the d-line in order to correct chromatic aberration that occurs on each flat surface. The flat image-side surface of the first lens unit B1 and the flat object-side surface of the second lens unit B2 can reduce the distance between the first lens unit B1 and the second lens unit B2 in the retracted state of the zoom lens.

Using high-order diffractive surfaces for all the diffractive surfaces can provide an aspheric effect, and correct both geometric and chromatic aberrations. All the diffractive surfaces are formed on a flat surface as a base surface, and reduce the difficulty of manufacturing each lens.

During focusing from infinity to a close distance, the third lens unit B3 is moved toward the image side. By configuring the third lens unit B3 as one single lens, the weight of the third lens unit B3 can be reduced and the focus drive mechanism can be simple. For image stabilization, the second lens unit B2 is shifted in a direction orthogonal to the optical axis. Another lens unit may be moved for each of focusing and image stabilization.

Placing the aperture stop SP between the second lens unit B2 and the third lens unit B3 can move the second lens unit B2, which has a large zoom effect, closer to the first lens unit B1, and achieve both a high zoom ratio and high performance.

### Example 5

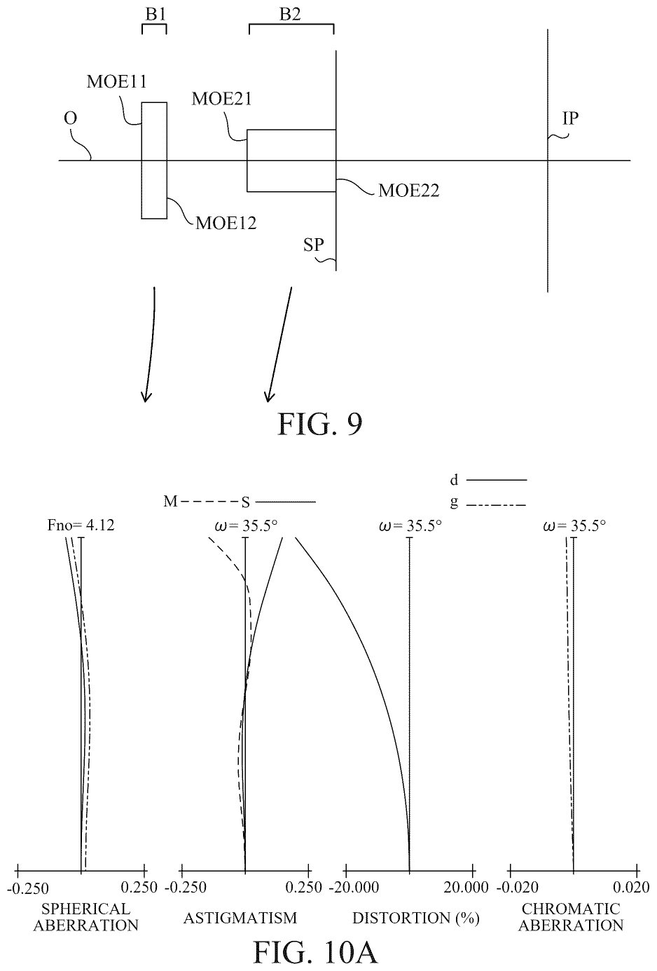

A zoom lens according to Example 5 (numerical example 5) illustrated in FIG. 9 is a zoom lens with a focal length of 9.06 to 17.75 mm, an F-number of 4.12 to 6.21, and a half angle of view of 35.52° to 23.97°. The zoom lens according to this example includes, in order from the object side to the image side, a first lens unit B1 with negative refractive power, a second lens unit B2 with positive refractive power, and an aperture stop SP. Although neither the first nor second lens unit B1 and B2 has curvature, they have a refractive effect due to their diffractive surfaces, so in this embodiment they are treated as lens units.

During zooming, all of the lens units B1 and B2 move, and each distance between adjacent lens units changes. During zooming from the wide-angle end to the telephoto end, the first lens unit B1 and the second lens unit B2 move toward the object side so as to reduce the distance between them. The first lens unit B1 moves in a convex trajectory toward the image side so that it returns to the same position at the telephoto end as that at the wide-angle end, and the second lens unit B2 moves toward the object side. Moving the first and second lens units B1 and B2 in this way can reduce the refractive powers of the first and second lens units B1 and B2 and the overall length of the zoom lens.

The first lens unit B1 consists of a single negative lens and has dispersion-controlled diffractive surfaces MOE11 and MOE12 on its object and image sides, respectively. The object-side diffractive surface MOE11 has negative refractive power, and the image-side diffractive surface MOE12 has positive refractive power. This configuration can correct distortion, curvature of field, and chromatic aberration in a well-balanced manner.

The second lens unit B2 consists of a single positive lens, and has dispersion-controlled diffractive surfaces MOE21 and MOE22 on the object side and image side, respectively. These diffractive surfaces MOE21 and MOE22 have positive refractive powers, and correct chromatic aberration, coma, and spherical aberration. A thick lens can create a difference in the position where the light ray passes between the object-side surface and the image-side surface, allowing the aberration correction to be shared.

Both the lenses of the first and second lens units B1 and B2 have flat surfaces on both sides, and are made of low-dispersion glass lenses with an Abbe number of 60 or more based on the d-line in order to correct chromatic aberration that occurs on each flat surface. The flat image-side surface of the first lens unit B1 and the flat object-side surface of the second lens unit B2 can reduce the distance between the first lens unit B1 and the second lens unit B2 in the retracted state of the zoom lens.

Using high-order diffractive surfaces for all diffractive surfaces can provide an aspheric effect, and correct both geometric and chromatic aberrations. All diffractive surfaces are formed on a flat surface as a base surface, and can reduce the difficulty of manufacturing each lens.

During focusing from infinity to a close distance, the first lens unit B1 is moved toward the object side. By configuring the first lens unit B1 as one single lens, the weight of the first lens unit B1 can be reduced and the focus drive mechanism can be simple.

Placing the aperture stop SP on the image side of the second lens unit B2 can move the second lens unit B2, which has a large zoom effect, closer to the first lens unit B1, and achieve both a high zoom ratio and high performance.

Each example achieves an optical path difference function of a dispersion-controlled diffractive surface by a metasurface in which a phase delay amount of the meta-atom is calculated for each wavelength and the meta-atoms are disposed to control the wavelength dispersion characteristic of the surface. The metasurface may be a so-called single-layer metasurface made of one layer, or a so-called stacked metasurface made of a plurality of layers. The aberrations generated by the zoom lens may be corrected by image processing in an image pickup apparatus.

Numerical examples 1 to 5 will be illustrated below. In each numerical example, a surface number i represents an order of the surface counted from the object side. r represents a radius of curvature (mm) of an i-th surface counted from the object side, d represents a lens thickness or air gap (mm) on the optical axis between i-th and (i+1)-th surfaces, and nd represents a refractive index for the d-line of an optical material between i-th and (i+1)-th surfaces. νd represents an Abbe number based on the d-line of an optical material between i-th and (i+1)-th surfaces.

The Abbe number νd based on the d-line is expressed as follows:

$$v d = ( Nd - 1 ) / ( NF - NC )$$

where Nd, NF, and NC are refractive indices for the d-line (587.6 nm), F-line (486.1 nm), and C-line (656.3 nm).

BF represents a back focus (mm). The back focus is a distance on the optical axis from a surface closest to the image plane (final surface) of the zoom lens to the paraxial image plane, expressed in air equivalent length. An “overall lens length” is a length on the optical axis from a surface closest to the object (frontmost surface) of the zoom lens to the final surface plus the back focus, and is also called the overall optical length.

An asterisk “*” next to a surface number means that the surface has an aspheric shape. The aspheric shape is expressed by the following equation:

$$x = ( {h}^{2} / R ) / [ 1 + {\{ 1 - ( 1 + k ) {( h / R )}^{2} \}}^{1 / 2} ] + A 4 \cdot {h}^{4} + A 6 \cdot {h}^{6} + A 8 \cdot {h}^{8} + A 10 \cdot {h}^{10}$$

where x is a displacement amount from a surface vertex in the optical axis direction, h is a height from the optical axis in a direction orthogonal to the optical axis, a light traveling direction is positive, R is a paraxial radius of curvature, k is a conic constant, and A4, A6, A8, and A10 are aspheric coefficients. “e±M” means×10^{±M}.

An optical path difference function ψ0 of a surface at a designed wavelength is expressed by the following equation:

$$ψ0 = U 2 \cdot {h}^{2} + U 4 \cdot {h}^{4} + U 6 \cdot {h}^{6} + U 8 \cdot {h}^{8} + U 10 \cdot {h}^{10}$$

where U2, U4, U6, U8, and U10 are coefficients of the optical path difference function of the surface.

(Diffraction) means the surface that has been optically designed using the optical path difference function of the surface. WIDE, MIDDLE, and TELE represent a wide-angle end, an intermediate zoom position, and a telephoto end, respectively.

Table 1 illustrates numerical values regarding inequalities (1) to (7) in numerical examples 1 to 5. Each numerical example satisfies all of the following inequalities (1) to (7).

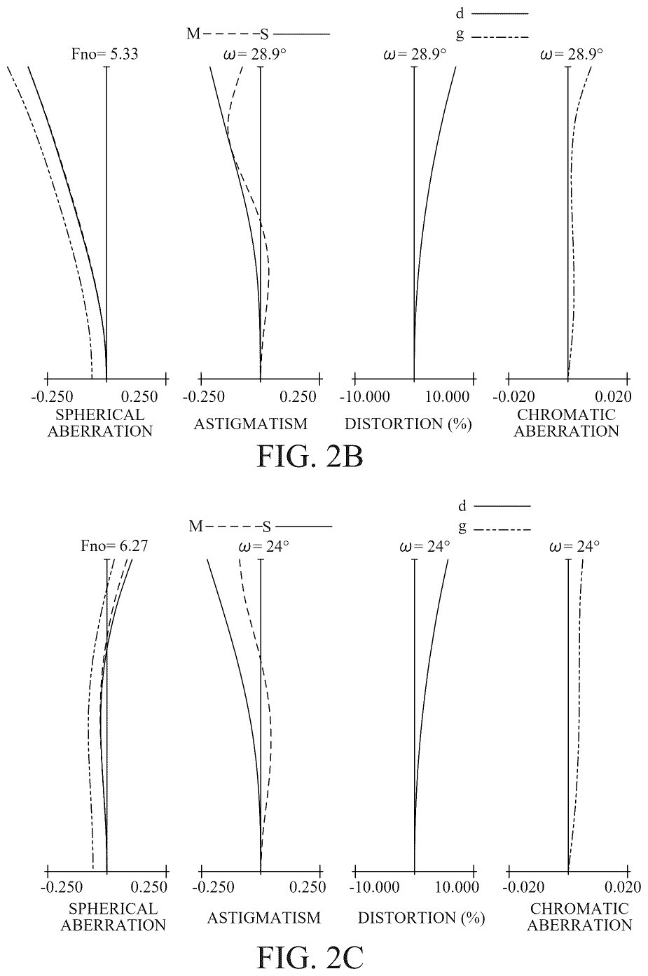

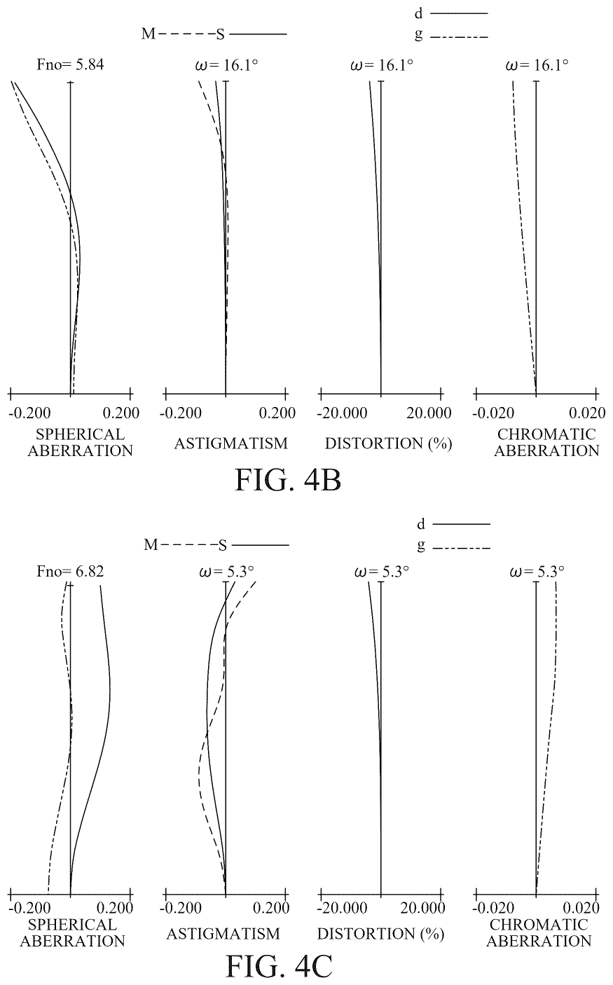

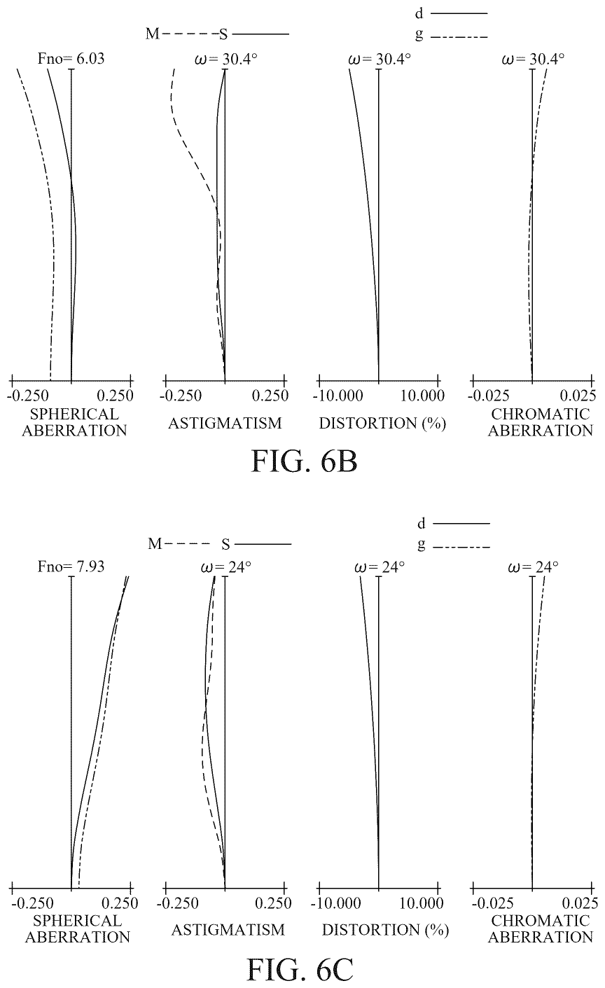

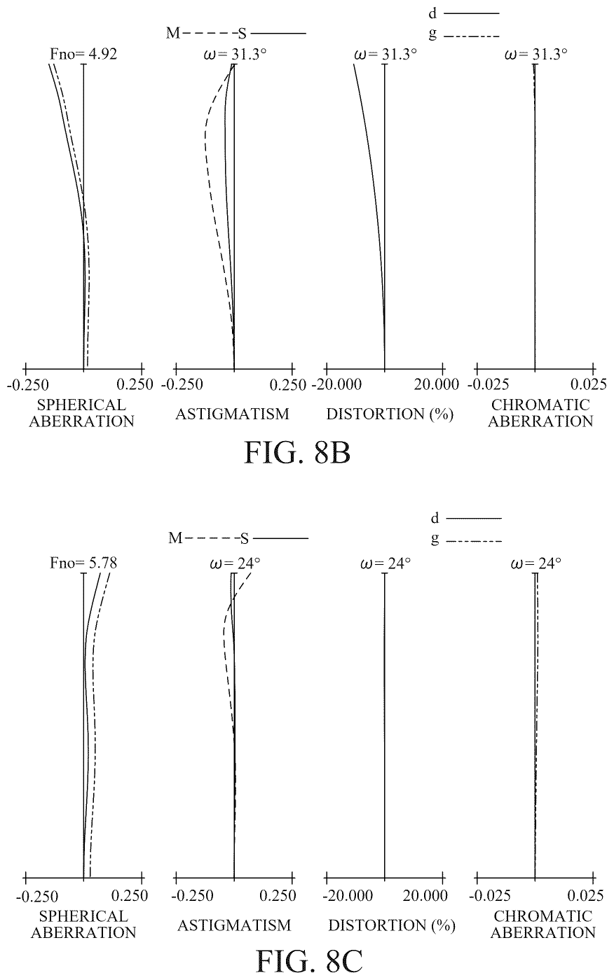

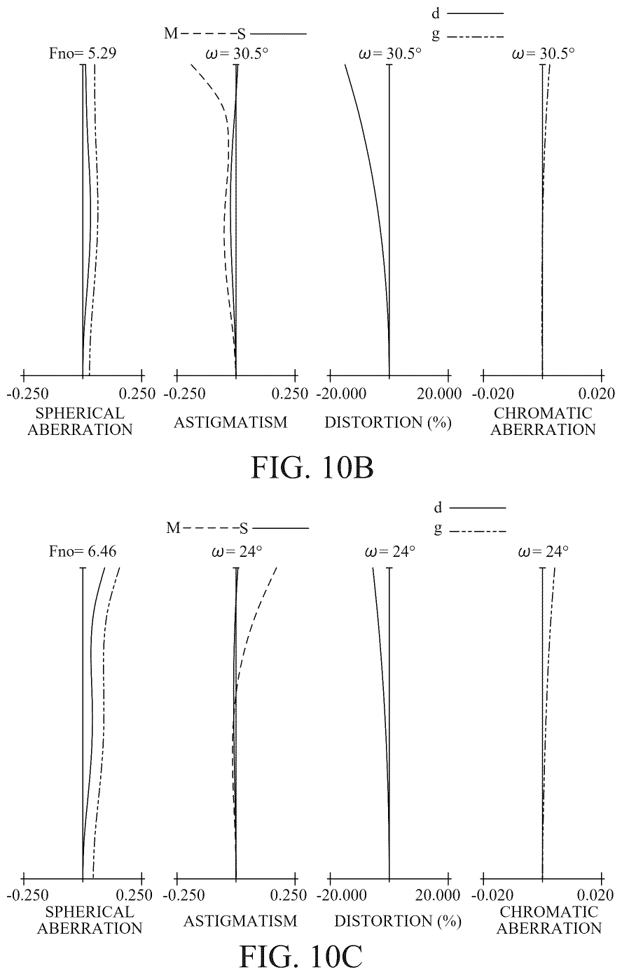

FIGS. 2A, 4A, 6A, 8A, and 10A respectively illustrate the longitudinal aberration (spherical aberration, astigmatism, distortion, and chromatic aberration) of the zoom lenses according to numerical examples 1 to 5 in an in-focus state at infinity at the wide-angle end. FIGS. 2B, 4B, 6B, 8B, and 10B respectively illustrate the longitudinal aberration of the zoom lenses according to numerical examples 1 to 5 in the in-focus state at infinity at an intermediate zoom position. FIGS. 2C, 4C, 6C, 8C, and 10C respectively illustrate the longitudinal aberration of the zoom lenses according to numerical examples 1 to 5 in the in-focus state at infinity at the telephoto end. In the spherical aberration diagram, Fno represents an F-number. A solid line indicates a spherical aberration amount for the d-line (with a wavelength of 587.6 nm), and a long and two short dashes line indicates spherical aberration at the g-line (a wavelength of 435.8 nm). In the astigmatism diagram, a solid line S indicates an astigmatism amount in a sagittal image plane, and a broken line M indicates an astigmatism amount in a meridional image plane. The distortion diagram illustrates a distortion amount for the d-line. The chromatic aberration diagram illustrates a lateral chromatic aberration amount for the g-line. ω represents a half angle of view (°).

NUMERICAL EXAMPLE 1
SURFACE DATA

| Surface No. | r | d | nd | νd |
|---|---|---|---|---|
| 1 (diffraction) | ∞ | 0.70 | 1.58313 | 59.4 |
| 2* | 12.744 | (Variable) | | |
| 3* | 5.061 | 1.71 | 1.49710 | 81.6 |
| 4 (diffraction) | ∞ | 2.91 | | |
| 5 (SP) | ∞ | (Variable) | | |
| 6* | −15.686 | 0.50 | 1.49710 | 81.6 |
| 7 (diffraction) | ∞ | (Variable) | | |
| 8 | ∞ | 0.55 | 1.51633 | 64.1 |
| 9 | ∞ | 0.86 | | |
| 10 | ∞ | 0.50 | 1.51633 | 64.1 |
| 11 | ∞ | (Variable) | | |
| Image Plane | ∞ | | | |

ASPHERIC DATA

1st Surface (diffractive surface)
U 2 = 1.16733e−02 U 4 = −5.60771e−04 U 6 = 4.53318e−05
U 8 = −1.34827e−06 U10 = 1.37813e−08
2nd Surface
K = −7.39509e+00 A 4 = 1.93534e−03 A 6 = −1.02565e−04
A 8 = 2.99088e−06 A10 = −1.55725e−08
3rd Surface
K = 0.00000e+00 A 4 = −1.15177e−04 A 6 = 7.58775e−05
A 8 = −1.24957e−05 A10 = 1.88105e−06
4th Surface (diffractive surface)
U 2 = −1.99346e−02 U 4 = 1.17636e−04 U 6 = 1.19021e−04
U 8 = −2.14007e−05 U10 = 2.70008e−06
6th Surface
K = 0.00000e+00 A 4 = −1.40481e−03 A 6 = −7.44242e−04
A 8 = 1.46738e−04 A10 = −1.86344e−05
7th Surface (diffractive surface)
U 2 = 5.70651e−03 U 4 = 3.16597e−04 U 6 = −2.52105e−04
U 8 = 3.92598e−05 U10 = −3.15610e−06

Optical Path Difference Dispersion of Surface

1st Surface, 4th Surface, 7th Surface
P(λ) = 2266.41068 · λ10 − 12144.39247 · λ9 + 29486.82651
· λ8 − 42762.08537 · λ7 + 41106.88437 · λ6 − 27470.79737 ·
λ5 + 13006.44877 · λ4 − 4356.52716 · λ3 + 1009.95630 · λ2 −
153.95668 · λ + 13.87546
P(λ_{d}) = 1.0000
P(λ_{C}) = 0.9156
P(λ_{F}) = 1.1842

VARIOUS DATA
Zoom Ratio 1.95

| | WIDE | MIDDLE | TELE |
|---|---|---|---|
| Focal Length | 9.06 | 14.28 | 17.72 |
| Fno | 4.12 | 5.33 | 6.27 |
| Half Angle of View (°) | 35.52 | 28.92 | 24.01 |
| Image Height | 6.47 | 7.89 | 7.89 |
| Overall Lens Length | 24.08 | 20.81 | 21.84 |
| BF (in air) | 8.15 | 9.17 | 12.13 |
| d2 | 8.80 | 3.22 | 1.94 |
| d5 | 0.95 | 2.24 | 1.60 |
| d7 | 5.40 | 6.42 | 9.37 |
| d11 | 1.20 | 1.20 | 1.20 |

NUMERICAL EXAMPLE 2
SURFACE DATA

| Surface No. | r | d | nd | νd |
|---|---|---|---|---|
| 1 | 22.742 | 2.14 | 1.49700 | 81.5 |
| 2 (diffraction) | ∞ | (Variable) | | |
| 3 (diffraction) | ∞ | 0.50 | 1.69680 | 55.5 |
| 4 | 9.825 | (Variable) | | |
| 5* | 3.718 | 1.40 | 1.76802 | 49.2 |
| 6 (diffraction) | ∞ | 0.05 | | |
| 7 (SP) | ∞ | 0.00 | | |
| 8 | 10.508 | 0.30 | 1.64769 | 33.8 |
| 9 | 2.745 | 1.44 | | |
| 10 | ∞ | (Variable) | | |
| 11 | 20.394 | 1.40 | 1.83481 | 42.7 |
| 12 (diffraction) | ∞ | (Variable) | | |
| 13 | ∞ | 0.30 | 1.51633 | 64.1 |
| 14 | ∞ | 0.52 | | |
| 15 | ∞ | 0.50 | 1.51633 | 64.1 |
| 16 | ∞ | (Variable) | | |
| Image Plane | ∞ | | | |

ASPHERIC DATA

2nd Surface (diffractive surface)
U 2 = −3.90092e−03 U 4 = 2.64576e−06 U 6 = 1.00228e−07
U 8 = −2.06308e−09 U10 = 1.67417e−11
3rd Surface (diffractive surface)
U 2 = 4.03024e−02 U 4 = −7.96691e−05 U 6 = 8.85646e−07
U 8 = −2.52786e−08 U10 = 4.17985e−10
5th Surface
K = −7.12564e−01 A 4 = 4.72706e−04 A 6 = 1.73220e−05
A 8 = −2.35441e−05
6th Surface (diffractive surface)
U 2 = −1.27570e−02 U 4 = 6.99982e−04 U 6 = −1.39118e−04
U 8 = −9.03648e−06
12th Surface (diffractive surface)
U 2 = −4.67880e−03 U 4 = −4.66633e−05 U 6 = −1.21998e−06
U 8 = 1.91916e−08

Optical Path Difference Dispersion of Surface

2nd Surface, 6th Surface, 12th Surface
P(λ) = 2266.41068 · λ10 − 12144.39247 · λ9 + 29486.82651
· λ8 − 42762.08537 · λ7 + 41106.88437 · λ6 − 27470.79737 ·
λ5 + 13006.44877 · λ4 − 4356.52716 · λ3 + 1009.95630 · λ2 −
153.95668 · λ + 13.87546
P(λ_{d}) = 1.0000
P(λ_{C}) = 0.9156
P(λ_{F}) = 1.1842
3rd Surface
P(λ) = 606.61668 · λ10 − 3567.44539 · λ9 + 9538.09656 ·
λ8 − 15288.88750 · λ7 + 16315.44261 · λ6 − 12165.39383 · λ5 +
6465.34198 · λ4 − 2448.35587 · λ3 + 647.33574 · λ2 − 113.77083 ·
λ + 11.97801
P(λ_{d}) = 1.0000
P(λ_{C}) = 0.9047
P(λ_{F}) = 1.1965

VARIOUS DATA
Zoom Ratio 9.70

| | WIDE | MIDDLE | TELE |
|---|---|---|---|
| Focal Length | 4.30 | 13.44 | 41.75 |
| Fno | 3.61 | 5.84 | 6.82 |
| Half Angle of View (°) | 37.44 | 16.08 | 5.30 |
| Image Height | 3.29 | 3.88 | 3.88 |
| Overall Lens Length | 35.68 | 43.08 | 55.50 |
| Overall Optical Length | 35.94 | 43.34 | 55.76 |
| BF (in air) | 5.79 | 7.86 | 9.53 |
| d2 | 0.30 | 7.20 | 18.43 |
| d4 | 17.86 | 8.42 | 3.50 |
| d10 | 4.75 | 12.64 | 17.07 |
| d12 | 4.21 | 6.28 | 7.95 |
| d16 | 0.53 | 0.53 | 0.53 |

NUMERICAL EXAMPLE 3
SURFACE DATA

| Surface No. | r | d | nd | νd |
|---|---|---|---|---|
| 1 | −6.229 | 0.50 | 1.49710 | 81.6 |
| 2 (diffraction) | ∞ | 0.94 | | |
| 3 (SP) | ∞ | 0.50 | | |
| 4* | 19.242 | 2.58 | 1.49710 | 81.6 |
| 5* | −3.518 | (Variable) | | |
| 6* | −8.433 | 0.50 | 1.80139 | 45.5 |
| 7 (diffraction) | ∞ | (Variable) | | |
| 8 | ∞ | 0.55 | 1.51633 | 64.1 |
| 9 | ∞ | 0.86 | | |
| 10 | ∞ | 0.50 | 1.51633 | 64.1 |
| 11 | ∞ | (Variable) | | |
| Image Plane | ∞ | | | |

ASPHERIC DATA

2nd Surface (diffractive surface)
U 2 = −2.49030e−02 U 4 = 4.32303e−04 U 6 = −4.02618e−04
U 8 = 2.18493e−04 U10 = −3.89805e−05
4th Surface
K = 0.00000e+00 A 4 = −4.13532e−03 A 6 = −7.65827e−04
5th Surface
K = 0.00000e+00 A 4 = 1.12893e−03 A 6 = −5.74274e−04
A 8 = 8.73569e−05 A10 = −1.10028e−05
6th Surface
K = −2.33772e+01 A 4 = −5.57520e−03 A 6 = 5.34799e−04
A 8 = −3.92900e−05 A10 = 9.59231e−07
7th Surface (diffractive surface)
U 2 = 8.54392e−03 U 4 = −1.10035e−03 U 6 = 1.38481e−04
U 8 = −9.99651e−06 U10 = 2.30160e−07

Optical Path Difference Dispersion of Surface

2nd Surface
P(λ) = 0.58756/λ
P(λ_{d}) = 1.0000
P(λ_{C}) = 0.8953
P(λ_{F}) = 1.2086
7th Surface
P(λ) = 533.20107 · λ10 − 3201.64587 · λ9 + 8717.86553 ·
λ8 − 14203.42791 · λ7 + 15380.55257 · λ6 − 11621.31727 ·
λ5 + 6251.15666 · λ4 − 2393.52390 · λ3 + 639.27445 · λ2 −
113.41301 · λ + 12.03846
P(λ_{d}) = 1.0000
P(λ_{C}) = 0.9000
P(λ_{F}) = 1.2024

VARIOUS DATA
Zoom Ratio 1.93

| | WIDE | MIDDLE | TELE |
|---|---|---|---|
| Focal Length | 9.19 | 13.44 | 17.69 |
| Fno | 4.12 | 6.03 | 7.93 |
| Half Angle of View (°) | 34.50 | 30.42 | 24.04 |
| Image Height | 6.31 | 7.89 | 7.89 |
| Overall Lens Length | 12.79 | 16.42 | 21.03 |
| BF | 3.13 | 8.80 | 14.47 |
| d5 | 4.65 | 2.61 | 1.55 |
| d7 | 0.44 | 6.11 | 11.78 |
| d11 | 1.14 | 1.14 | 1.14 |

NUMERICAL EXAMPLE 4
SURFACE DATA

| Surface No. | r | d | nd | νd |
|---|---|---|---|---|
| 1 (diffraction) | ∞ | 0.50 | 1.51633 | 64.1 |
| 2 (diffraction) | ∞ | (Variable) | | |
| 3 (diffraction) | ∞ | 0.50 | 1.51633 | 64.1 |
| 4 | ∞ | 0.00 | | |
| 5 (SP) | ∞ | (Variable) | | |
| 6 (diffraction) | ∞ | 0.50 | 1.51633 | 64.1 |
| 7 | ∞ | (Variable) | | |
| Image Plane | ∞ | | | |

ASPHERIC DATA

1st Surface (diffractive surface)
U 2 = 9.52759e−02 U 4 = 1.92148e−03 U 6 = 4.62097e−05
U 8 = −1.22395e−05 U10 = 4.94686e−07
2nd Surface (diffractive surface)
U 2 = −5.79118e−02 U 4 = −1.48228e−03 U 6 = −3.23889e−07
U 8 = 7.49816e−06 U10 = −3.21850e−07
3rd Surface (diffractive surface)
U 2 = −5.11424e−02 U 4 = 2.30016e−05 U 6 = −9.14201e−05
U 8 = 2.82694e−05 U10 = −3.43660e−06
6th Surface (diffractive surface)
U 2 = −8.37514e−03 U 4 = 2.08999e−04 U 6 = −3.05321e−06
U 8 = 2.51364e−07 U10 = −6.82706e−09

Optical Path Difference Dispersion of Surface

1st Surface, 2nd Surface, 3rd Surface, 6th Surface
P(λ) = 0.58756/λ
P(λ_{d}) = 1.0000
P(λ_{C}) = 0.8953
P(λ_{F}) = 1.2086

VARIOUS DATA
Zoom Ratio 1.96

| | WIDE | MIDDLE | TELE |
|---|---|---|---|
| Focal Length | 9.06 | 12.98 | 17.75 |
| Fno | 4.12 | 4.92 | 5.78 |
| Half Angle of View (°) | 35.52 | 31.30 | 23.97 |
| Image Height | 6.47 | 7.89 | 7.89 |
| Overall Lens Length | 22.00 | 21.43 | 22.00 |
| BF | 11.49 | 11.33 | 13.45 |
| d2 | 6.85 | 3.01 | 0.30 |
| d5 | 2.17 | 5.60 | 6.75 |
| d7 | 11.49 | 11.33 | 13.45 |

NUMERICAL EXAMPLE 5
SURFACE DATA

| Surface No. | r | d | nd | νd |
|---|---|---|---|---|
| 1 (diffraction) | ∞ | 1.54 | 1.51633 | 64.1 |
| 2 (diffraction) | ∞ | (Variable) | | |
| 3 (diffraction) | ∞ | 5.39 | 1.51633 | 64.1 |
| 4 (diffraction) | ∞ | 0.00 | | |
| 5 (SP) | ∞ | (Variable) | | |
| Image Plane | ∞ | | | |

ASPHERIC DATA

1st Surface (diffractive surface)
U 2 = 7.12979e−02 U 4 = 1.51365e−03 U 6 = 5.21235e−05
U 8 = −4.85827e−06 U10 = 1.47453e−08
2nd Surface (diffractive surface)
U 2 = −1.83870e−02 U 4 = −1.00835e−03 U 6 = −1.20402e−05
U 8 = 4.64800e−06 U10 = −7.44672e−08
3rd Surface (diffractive surface)
U 2 = −4.96083e−02 U 4 = −5.36448e−05 U 6 = 1.38943e−06
U 8 = −5.63052e−06 U10 = 8.02406e−07
4th Surface (diffractive surface)
U 2 = −1.73067e−02 U 4 = 3.39963e−04 U 6 = −1.00376e−04
U 8 = 4.34611e−05 U10 = −6.13235e−06

Optical Path Difference Dispersion of Surface

1st Surface, 2nd Surface, 3rd Surface, 4th Surface
P(λ) = 0.58756/λ
P(λ_{d}) = 1.0000
P(λ_{C}) = 0.8953
P(λ_{F}) = 1.2086

VARIOUS DATA
Zoom Ratio 1.96

| | WIDE | MIDDLE | TELE |
|---|---|---|---|
| Focal Length | 9.06 | 13.41 | 17.75 |
| Fno | 4.12 | 5.29 | 6.46 |
| Half Angle of View (°) | 35.52 | 30.48 | 23.97 |
| Image Height | 6.47 | 7.89 | 7.89 |
| Overall Lens Length | 24.59 | 25.25 | 27.35 |
| BF | 12.81 | 16.40 | 19.99 |
| d2 | 4.85 | 1.92 | 0.43 |
| d5 | 12.81 | 16.40 | 19.99 |

TABLE 1
Inequality (1)

| | Ex 1 | Ex 2 | Ex 3 | Ex 4 | Ex 5 |
|---|---|---|---|---|---|
| fm11 | −42.833 | — | — | −5.248 | −7.013 |
| fm12 | — | 128.175 | 20.078 | 8.634 | 27.193 |
| fm21 | — | −12.406 | — | 9.777 | 10.079 |
| fm22 | 25.082 | — | −58.521 | — | 28.890 |
| fm31 | — | — | — | 59.701 | — |
| fm32 | −87.619 | 39.194 | — | — | — |
| fm41 | — | — | — | — | — |
| fm42 | — | 106.865 | — | — | — |
| f1 | −14.373 | 34.000 | 6.663 | −14.826 | −9.950 |
| f2 | 7.484 | −6.527 | −8.884 | 9.777 | 8.222 |
| f3 | −23.136 | 10.411 | — | 59.701 | — |
| f4 | — | 20.000 | — | — | — |
| f1/fm11 | 0.336 | — | — | 2.825 | 1.419 |
| f1/fm12 | — | 0.265 | 0.332 | −1.717 | −0.366 |
| f2/fm21 | — | 0.526 | — | 1.000 | 0.816 |
| f2/fm22 | 0.298 | — | 0.152 | — | 0.285 |
| f3/fm31 | — | — | — | 1.000 | — |
| f3/fm32 | 0.264 | 0.266 | — | — | — |
| f4/fm41 | — | — | — | — | — |
| f4/fm42 | — | 0.187 | — | — | — |

Inequality (2)

| | Ex 1 | Ex 2 | Ex 3 | Ex 4 | Ex 5 |
|---|---|---|---|---|---|
| 1/vd(moe11) | −0.043 | — | — | 0.000 | 0.000 |
| 1/vd(moe12) | — | −0.043 | 0.000 | 0.000 | 0.000 |
| 1/vd(moe21) | — | −0.021 | — | 0.000 | 0.000 |
| 1/vd(moe22) | −0.043 | — | −0.010 | — | 0.000 |
| 1/vd(moe31) | — | — | — | 0.000 | — |
| 1/vd(moe32) | −0.043 | −0.043 | — | — | — |
| 1/vd(moe41) | — | — | — | — | — |
| 1/vd(moe42) | — | −0.043 | — | — | — |

Inequality (3) (4)

| | Ex 1 | Ex 2 | Ex 3 | Ex 4 | Ex 5 |
|---|---|---|---|---|---|
| Dsum | 2.914 | 5.791 | 5.013 | 1.500 | 6.925 |
| fw | 9.064 | 4.302 | 9.187 | 9.064 | 9.064 |
| ft | 17.717 | 41.748 | 17.694 | 17.751 | 17.751 |
| ωT | 24.010 | 5.303 | 24.039 | 23.970 | 23.970 |
| Dsum/√ (fw · ft) | 0.230 | 0.432 | 0.393 | 0.118 | 0.546 |
| Dsum/(ft · tanωT) | 0.369 | 1.495 | 0.635 | 0.190 | 0.877 |

Inequality (5)

| Reference R of each surface | Ex 1 | Ex 2 | Ex 3 | Ex 4 | Ex 5 |
|---|---|---|---|---|---|
| RefR(s11) | INF | 22.742 | −6.229 | INF | INF |
| RefR(s12) | 10.033 | INF | INF | INF | INF |
| RefR(s13) | — | — | 49.583 | — | — |
| RefR(s14) | — | — | −3.394 | — | — |
| RefR(s21) | 5.006 | INF | −6.698 | INF | INF |
| RefR(s22) | INF | 9.825 | INF | INF | INF |
| RefR(s31) | −10.826 | 3.867 | — | INF | — |
| RefR(s32) | INF | INF | — | INF | — |
| RefR(s33) | — | 10.508 | — | — | — |
| RefR(s34) | — | 2.745 | — | — | — |
| RefR(s41) | — | 20.394 | — | — | — |
| RefR(s42) | — | INF | — | — | — |
| Lens surface R12 closest to | 10.033 | 1.E+30 | −3.394 | 1.E+30 | 1.E+30 |
| image plane in first lens unit | | | | | |
| Lens surface R21 closest to | 5.006 | 1.E+30 | −6.698 | 1.E+30 | 1.E+30 |
| object in second lens unit | | | | | |
| Lens surface R22 closest to | 1.E+30 | 9.825 | — | 1.E+30 | — |
| image plane in second lens unit | | | | | |
| Lens surface R31 closest to | −10.826 | 3.867 | — | 1.E+30 | — |
| object in third lens unit | | | | | |
| Lens surface R32 closest to | — | 2.745 | — | — | — |
| image plane in third lens unit | | | | | |
| Lens surface R41 closest to | — | 20.394 | — | — | — |
| object in fourth lens unit | | | | | |
| (R21 − R12)/(R21 + R12) | −0.334 | 0.000 | 0.327 | 0.000 | 0.000 |
| (R31 − R22)/(R31 + R22) | −1.000 | −0.435 | — | 0.000 | — |
| (R41 − R32)/(R41 + R32) | — | 0.763 | — | — | — |

Inequality (6) (7)

| | Ex 1 | Ex 2 | EX 3 | Ex 4 | Ex 5 |
|---|---|---|---|---|---|
| f1/f2 | −1.920 | −5.209 | −0.750 | −1.516 | −1.210 |
| f2/ft | 0.422 | −0.156 | −0.502 | 0.551 | 0.463 |

### Image Pickup Apparatus

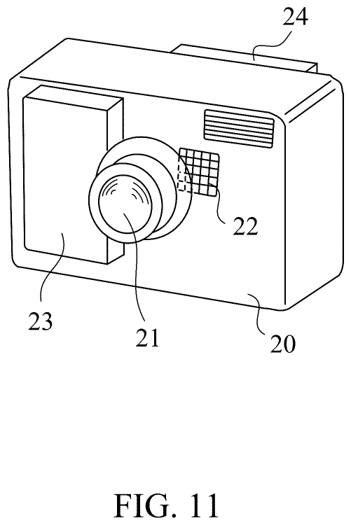

FIG. 11 illustrates a digital still camera as an image pickup apparatus using the zoom lens according to any one of the above examples as an imaging optical system. Reference numeral 20 denotes a camera body, and reference numeral 21 denotes an imaging optical system including any one of the zoom lenses according to Examples 1 to 5. Reference numeral 22 denotes a solid-state image sensor such as a CCD sensor or CMOS sensor that is built into the camera body 20 and photoelectrically converts an optical image (object image) formed by the imaging optical system 21, that is, captures the object image through the imaging optical system 21. Reference numeral 23 denotes a recorder configured to record image data generated by processing an imaging signal from the image sensor 22, and reference numeral 24 denotes a rear display that displays the image data.

By using the zoom lens according to each example, a small camera with high optical performance can be obtained. In particular, it is possible to reduce chromatic aberration and mitigate an incident angle on the image sensor 22. The camera may be a single-lens reflex camera with a quick-turn mirror, or a mirrorless camera without a quick-turn mirror.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide a zoom lens having better optical performance than ever.

This application claims priority to Japanese Patent Application No. 2024-080635, which was filed on May 17, 2024, and Japanese Patent Application No. 2025-022075, which was filed on Feb. 14, 2025, each of which is hereby incorporated by reference herein in their entirety.

What is claimed is:

1. A zoom lens comprising:
a plurality of lens units,
wherein each distance between adjacent lens units changes during zooming,
wherein at least one of the plurality of lens units has a diffractive surface with controlled wavelength dispersion, and
wherein the following inequality is satisfied:
$$0.28 \leq 1 / {v}_{0} \leq 0.$$
where ν₀ is an Abbe number of the diffractive surface and satisfies the following equation, a reference wavelength is d-line, a primary dispersion is F-line and C-line, ψ(λ_{d}), ψ(λ_{F}) and ψ(λ_{C}) are optical path difference functions at wavelengths of the d-line, the F-line and the C-line, respectively, P(λ_{d}), P(λ_{F}) and P(λ_{C}) are optical path difference dispersions of a surface at the wavelengths of the d-line, the F-line, and the C-line, respectively:
$$\frac{1}{{v}_{0}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )} .$$

2. The zoom lens according to claim 1, wherein the following inequality is satisfied:
0.15≤fi/fmi≤10.00
where fi is a focal length of a lens unit having the diffractive surface, and fmi is a focal length of the diffractive surface.

3. The zoom lens according to claim 1, wherein the following inequality is satisfied:
$$0.05 \leq Dum / √ ( fw \cdot ft ) \leq 0.8$$
where Dsum is a sum of thicknesses on an optical axis of the plurality of lens units, fw and ft are focal lengths of the zoom lens at a wide-angle end and a telephoto end in an in-focus state on an object at infinity, respectively.

4. The zoom lens according to claim 1, wherein the following inequality is satisfied:
$$0.1 \leq Dsum / ( ft \cdot tan ω T ) \leq 2.$$
where Dsum is a sum of thicknesses on an optical axis of the plurality of lens units, ft is a focal length of the zoom lens at a telephoto end in an in-focus state on an object at infinity, and ωT is a half angle of view of the zoom lens at the telephoto end in the in-focus state on the object at infinity.

5. The zoom lens according to claim 1, wherein the following inequality is satisfied:
$$\vert ( R ( i + 1 ) 1 - Ri 2 ) / ( R ( i + 1 ) 1 + Ri 2 ) \vert \leq 2.$$
where Ri2 is a radius of curvature of a lens surface closest to an image plane in an i-th lens unit counted from an object side among the plurality of lens units, and R(i+1)1 is a radius of curvature of a lens surface closest to an object in an (i+1)-th lens unit counted from the object side among the plurality of lens units.

6. The zoom lens according to claim 1, wherein the plurality of lens units consist of, in order from an object side to an image side, a first lens unit with negative refractive power and a second lens unit with positive refractive power, and
wherein the following inequality is satisfied:
$$- 2.1 \leq f 1 / f 2 \leq - 1.$$
where f1 is a focal length of the first lens unit, and f2 is a focal length of the second lens unit.

7. The zoom lens according to claim 1, wherein the plurality of lens units consist of, in order from an object side to an image side, a first lens unit with positive refractive power and a second lens unit with negative refractive power, and
wherein the following inequality is satisfied:
$$- 0.8 \leq f 2 / ft \leq - 0.05$$
where f2 is a focal length of the second lens unit, and ft is a focal length of the zoom lens at a telephoto end in an in-focus state on an object at infinity.

8. The zoom lens according to claim 1, further comprising at least one refractive surface.

9. The zoom lens according to claim 1, wherein a lens unit having the diffractive surface includes two lenses or less.

10. The zoom lens according to claim 1, wherein each of the plurality of lens units includes two lenses or less.

11. The zoom lens according to claim 1, wherein the diffractive surface is formed on a flat surface as a base surface.

12. The zoom lens according to claim 1, wherein the plurality of lens units consist of, in order from an object side to an image side, a first lens unit with negative refractive power, a second lens unit with positive refractive power, and a third lens unit with negative refractive power, and
wherein the first lens unit, the second lens unit, and the third lens unit move during zooming.

13. The zoom lens according to claim 1, wherein the plurality of lens units consist of, in order from an object side to an image side, a first lens unit with positive refractive power, a second lens unit with negative refractive power, a third lens unit with positive refractive power, and a fourth lens unit with positive refractive power, and
wherein the first lens unit, the second lens unit, the third lens unit, and the fourth lens unit move during zooming.

14. The zoom lens according to claim 1, wherein the plurality of lens units consist of, in order from an object side to an image side, a first lens unit with positive refractive power, and a second lens unit with positive refractive power, and
wherein the first lens unit, and the second lens unit move during zooming.

15. The zoom lens according to claim 1, wherein the plurality of lens units consist of, in order from an object side to an image side, a first lens unit with negative refractive power, and a second lens unit with positive refractive power, and
wherein the first lens unit, and the second lens unit move during zooming.

16. A zoom lens comprising:
a plurality of lens units,
wherein each distance between adjacent lens units changes during zooming,
wherein at least one of the plurality of lens units has a diffractive surface with controlled wavelength dispersion,
wherein at least one of the plurality of lens units has a refractive surface, and
wherein the following inequality is satisfied:
$$1 / {v}_{0} \leq 0.$$
where ν₀ is an Abbe number of the diffractive surface and satisfies the following equation, a reference wavelength is d-line, a primary dispersion is F-line and C-line, ψ(λ_{d}), ψ(λ_{F}) and ψ(λ_{C}) are optical path difference functions at wavelengths of the d-line, the F-line and the C-line, respectively, P(λ_{d}), P(λ_{F}) and P(λ_{C}) are optical path difference dispersions of a surface at the wavelengths of the d-line, the F-line, and the C-line, respectively:
$$\frac{1}{{v}_{0}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )} .$$

17. An image pickup apparatus comprising:
a zoom lens; and
an image sensor configured to capture an object image through the zoom lens,
wherein the zoom lens includes:
a plurality of lens units,
wherein each distance between adjacent lens units changes during zooming,
wherein at least one of the plurality of lens units has a diffractive surface with controlled wavelength dispersion, and
wherein the following inequality is satisfied:
$$- 0.28 \leq 1 / {v}_{0} \leq 0.$$
where ν₀ is an Abbe number of the diffractive surface and satisfies the following equation, a reference wavelength is d-line, a primary dispersion is F-line and C-line, ψ(λ_{d}), ψ(λ_{F}) and ψ(λ_{C}) are optical path difference functions at wavelengths of the d-line, the F-line and the C-line, respectively, P(λ_{d}), P(λ_{F}) and P(λ_{C}) are optical path difference dispersions of a surface at the wavelengths of the d-line, the F-line, and the C-line, respectively:
$$\frac{1}{{v}_{0}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )} .$$

18. An image pickup apparatus comprising:
a zoom lens; and
an image sensor configured to capture an object image through the zoom lens,
wherein the zoom lens includes:
a plurality of lens units,
wherein each distance between adjacent lens units changes during zooming,
wherein at least one of the plurality of lens units has a diffractive surface with controlled wavelength dispersion,
wherein at least one of the plurality of lens units has a refractive surface, and
wherein the following inequality is satisfied:
$$1 / {v}_{0} \leq 0. .$$
where ν₀ is an Abbe number of the diffractive surface and satisfies the following equation, a reference wavelength is d-line, a primary dispersion is F-line and C-line, ψ(λ_{d}), ψ(λ_{F}) and ψ(λ_{C}) are optical path difference functions at wavelengths of the d-line, the F-line and the C-line, respectively, P(λ_{d}), P(λ_{F}) and P(λ_{C}) are optical path difference dispersions of a surface at the wavelengths of the d-line, the F-line, and the C-line, respectively:
$$\frac{1}{{v}_{0}} ≡ \frac{ψ ( {λ}_{F} ) - ψ ( {λ}_{C} )}{ψ ( {λ}_{d} )} = \frac{{λ}_{F} P ( {λ}_{F} ) - {λ}_{C} P ( {λ}_{C} )}{{λ}_{d} P ( {λ}_{d} )} .$$
